(19) United States
(12) Patent Application Publication
(10) Pub. No.: US 2004/0225554 A1
(43) Pub. Date: Nov. 11, 2004

(54) Business method for information technology services for legacy applications of a client

(75) Inventors: Jeremy A. Chiappetta, Cambridge, MA (US); Jonathan M. Cohn, Springfield, NJ (US); Ellen R. Dulberger, Mahopac, NY (US); Marcelo C. Magalhaes, Somerville, MA (US)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY

(21) Appl. No.: 10/431,723

(22) Filed: May 8, 2003

(51) Int. Cl. G06F 17/60

(52) U.S. Cl. 705/10

(57) ABSTRACT

An information technology services company provides legacy software maintenance to a client company. Components for transformation of legacy software applications are predefined based on market research. Service elements and questions corresponding thereto are also defined. Service elements may have value drivers defined. Responses to the questions are received from the client as parameters for the service elements. Certain service elements are selected and priced by determining business value from the parameters. The selected service elements are then delivered to the client.

### TECHNICAL FIELD

The invention relates generally to a method of providing information technology services to a business client. More particularly the invention relates to delivery of services for transformation of a client's legacy applications.

### RELATED APPLICATIONS

This invention is related to a patent application entitled “SOFTWARE APPLICATION PORTFOLIO MANAGEMENT FOR A CLIENT” filed ______ and owned by common assignee—International Business Machines Corporation of Armonk, N.Y.

### BACKGROUND OF THE INVENTION

Businesses today operate using software applications which are decades-old. These legacy applications typically run 70 percent of the world's major business operations. Such applications handle, for example, credit card transactions, payroll systems, manufacturing processes, and stock trades. Much of this software code, because of its age, has been modified numerous times.

These legacy applications run business's daily operations and therefore must be maintained even though eighty percent of a typical company software budget is spent on such maintenance, leaving little for development of new applications. Legacy applications may be written in older programming languages such as COBOL (common business oriented language) which were developed long before today's open standards, web enabled applications, and web services, preventing integration with newer applications running in current environments.

Information technology (IT) services providing companies see this great expense in their client companies as an opportunity to provide such maintenance. For example, the client may be convinced to outsource this legacy application maintenance work to an IT services company. Before a company makes a decision to outsource such work, there must be a clear financial benefit to do so. Various financial measures are typically used by a client to evaluate whether any plan to outsource IT services is sufficiently beneficial to the client. For example, ROI (return on investment) calculations are well known in the business and accounting arts. ROI is described as a ratio of income to investment in Managerial Accounting by Morse and Zimmerman, Irwin McGraw-Hill, Boston 1997, page 477. Calculations for other financial measures of a business plan are also described by Morse and Zimmerman such as internal rate of return (IRR), net present value (NPV), and break even analysis. The investment represents expenditures to be made by the client to the IT services company. Income represents financial benefits the client enjoys at certain points in time, such as reduced expenditures in future periods. Financial considerations, such as time value of money, and costs of financing alternatives may be included in the calculations.

Various tools and spreadsheet techniques are available to assist in calculating business measures such as ROI. Spreadsheets are described below in connection with step 18 of FIG. 1. A websphere ROI tool is also available from IBM as described in the article “WebSphere software platform” dated Apr. 16, 2003.

Nevertheless, although IT services companies have been in operation for many years, 80% of IT budgets are still needed to support legacy applications, whether spent internally or outsourced. Any method which reduces this large expenditure for maintenance of legacy applications would therefore be a desirable improvement. It is believed that such a method would constitute a significant improvement in the art of providing IT services.

### OBJECTS AND SUMMARY OF THE INVENTION

It is therefore a principal object of the present invention to enhance the IT services arts by providing a method with enhanced capabilities.

It is another object to provide such a method wherein enhanced operational capabilities are possible.

It is yet another object to provide a method of providing IT services for legacy applications which can be accomplished in a facile manner.

These and other objects are attained in accordance with one embodiment of the invention wherein there is provided a method of transforming legacy business services for a client, comprising the steps of, predefining components having service elements and corresponding questions, based on market research, receiving from a client parameters for the service elements as responses to the questions, selecting and pricing service elements for the client by determining business value of the service elements from the parameters, and delivering the selected service elements to the client.

In accordance with yet another embodiment of the invention there is provided a program storage device readable by a machine, tangibly embodying a program of instructions executable by a machine to perform method steps for transforming legacy business services for a client, comprising, predefining components having service elements and corresponding questions, based on market research, receiving from a client parameters for the service elements as responses to the questions, selecting and pricing service elements for the client by determining business value of the service elements from the parameters, and thereafter, delivering the selected service elements to the client.

In accordance with yet another embodiment of the invention there is provided a business method of providing information technology services to a client for transforming legacy applications, comprising the steps of, predefining components having service elements for legacy applications of a client, each service element having one or more value drivers with corresponding parameters, determining values for the corresponding parameters through collaboration with the client, selecting service elements for the legacy applications of the client based on evaluating the value drivers using the values for the corresponding parameters, and delivering the selected service elements to the client.

### BRIEF DESCRIPTION OF THE DRAWINGS

FIG. 1 is a flowchart illustrating various steps in an embodiment of the present invention;

FIG. 2 illustrates input data parameters which may be entered in a tool for determining business value;

FIG. 3 depicts components and service elements in one embodiment of the present invention;

FIG. 4 shows ROI calculation results in graphical form; and

FIG. 5 illustrates business value calculations for a service element.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

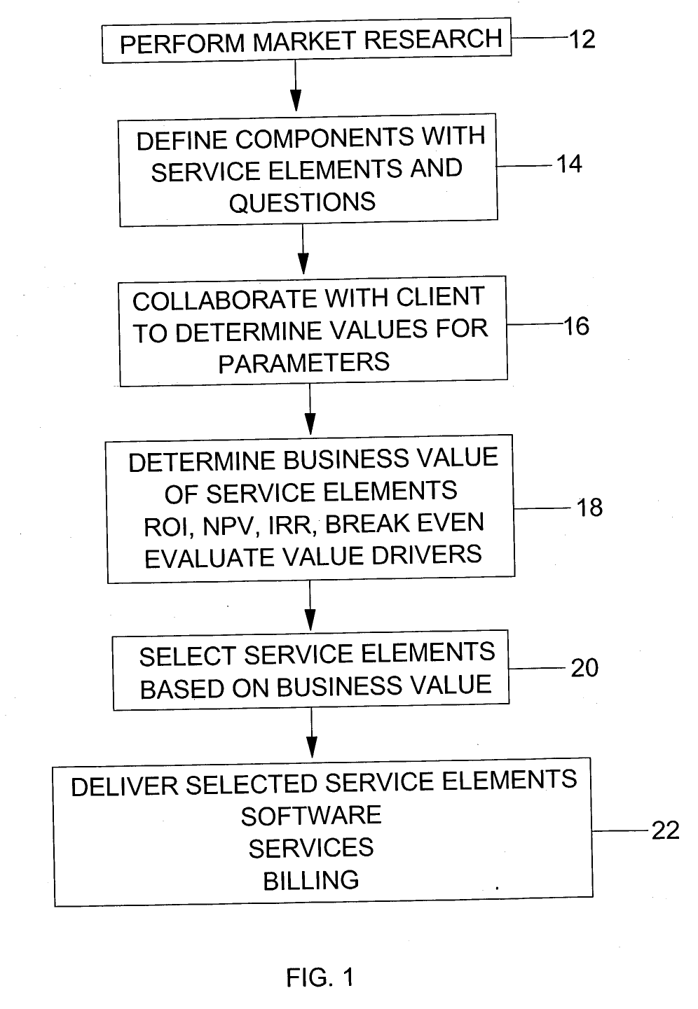

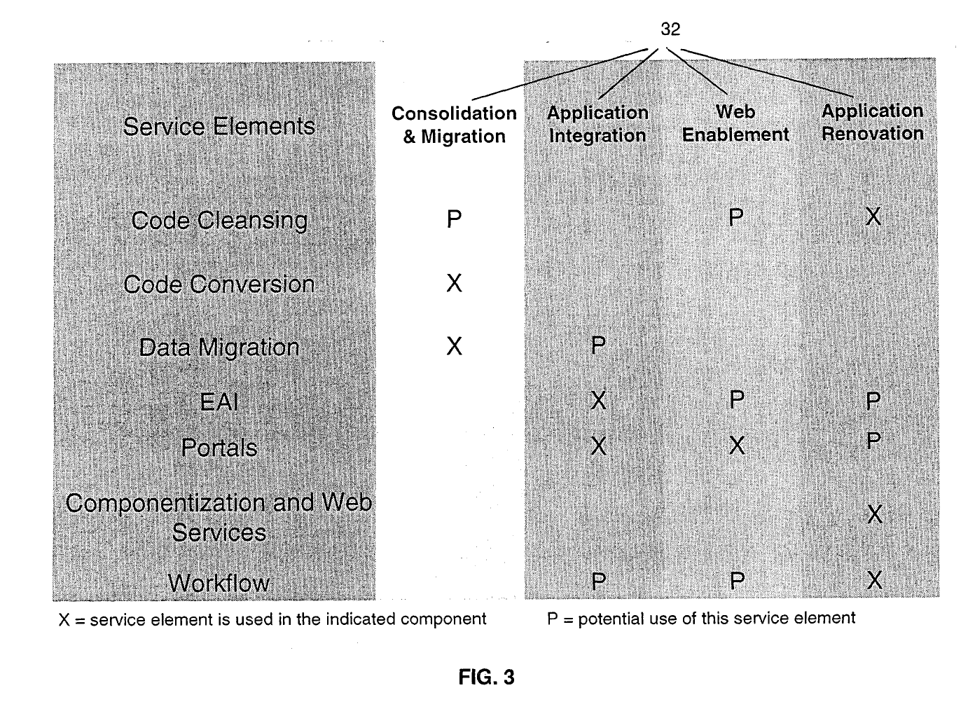

In FIG. 1 there is shown a flowchart of steps in accordance with carrying out the present invention. In step 12, an IT services providing company, performs market research. The purpose of the market research is to define the components and service elements applicable to legacy transformation services. FIG. 3 described below depicts one embodiment of such components and service elements. Primary and secondary market research may be performed. Primary research involves interviewing marketing personnel within the IT services company to capture their knowledge of the legacy transformation components and service elements within the legacy application services market. Secondary research involves reviewing reports of companies which analyze this market. For example “Gartner Reports” from Gartner, Inc. a technology research and advisory firm located in Stamford, Conn. may be reviewed. Reports from IDC located in Framingham, Mass. may also be reviewed. Reports from other companies which research this market may be reviewed.

In order to determine the business value of any particular service element in a particular component defined in step 14, a set of questions is predefined in step 14 based upon the market research performed in step 12.

In step 16, the IT services company receives responses to the questions from the client as values of parameters. The IT company may collaborate with the client in order to assist in understanding what values should be used for the parameters. In cases where data is unavailable, joint assumptions may be agreed upon on what value to use for a parameter.

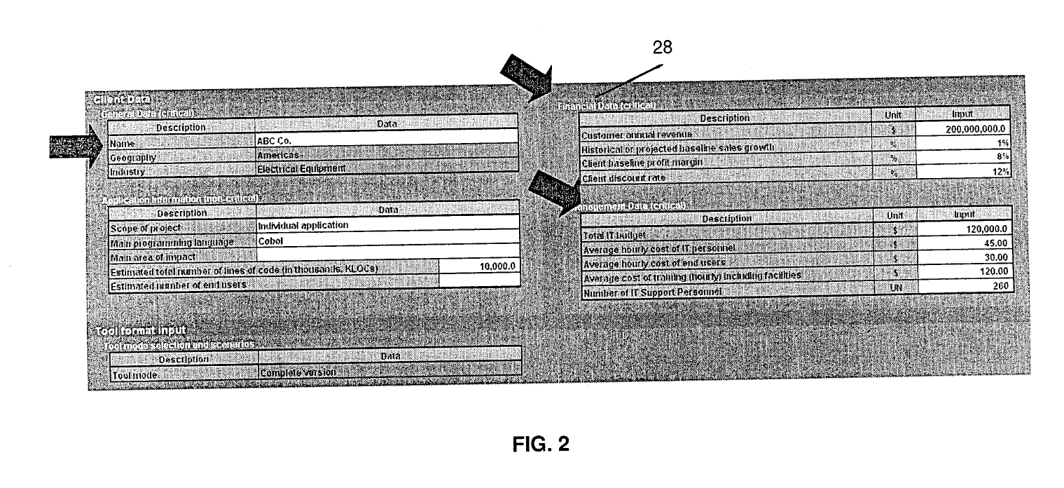

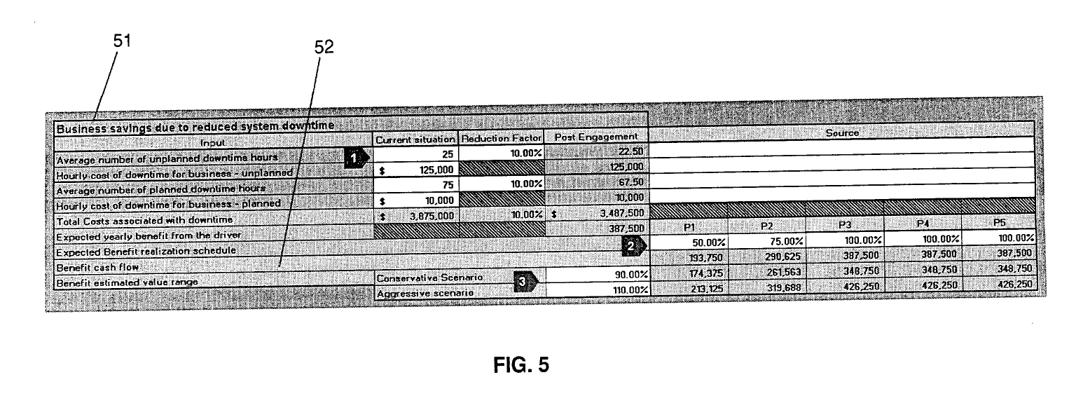

In step 18 the business value of each service element is determined based on the parameters received in step 16. Although calculators and interest rate tables have been used for calculating financial measures such as ROI, NPV, IRR, and the like in the past, the use of spreadsheet software tools is now more common. LOTUS 1-2-3® (LOTUS 1-2-3 is a trademark of Lotus Development Corporation, Cambridge, Mass.) and EXCEL® (EXCEL is a trademark of Microsoft Corp., Redmond, Wash.) are examples of spreadsheet software currently available which may be used for such calculations. FIGS. 2 and 5, described below, illustrate spreadsheet pages adapted for entering data and performing financial measure calculations.

The business value determination in step 18 is performed for each of the applicable services elements for a client. Based on these business value determinations, together with other factors which may be applicable, a set of service elements are selected in step 20, for example, the elements having the highest business value for the client.

In step 22 the IT Services company delivers the selected service elements to the client. This delivery may be in the form of software, either off the shelf or specially developed, and services such as support software development, data entry, customer billings, help desk support, or other services known in the IT industry. As described below, service elements may include e-business on demand services, in which case the client is billed based on actual use of this service.

In FIG. 2 there is shown a spreadsheet page for entry of parameter values received from a client. Financial data 28 for the client may be entered as shown in the upper right portion. In addition, general data, and management data may be entered as well as data pertaining to a particular application.

In FIG. 3 there is shown a chart listing the four components 32 for legacy transformation of consolidation and migration, application integration, web enablement, and application renovation, in one embodiment of the present invention. Also shown in FIG. 3 are the seven service elements and an indication of which service elements are used or potentially used in each of the four components.

The consolidation and migration component migrates applications and data to new technologies and consolidates redundant data repositories for less complex, more cost effective application operations. Application integration extends legacy application functionality and improves data sharing across front- and back-end systems for more efficient business processes and better decisions. The web enablement component web-enables legacy applications for seamless access to cross-platform data and business logic enabling better collaboration with the client's customers and partners. Application renovation enables application responsiveness to business needs by transforming legacy applications into flexible, componentized, and reusable business assets.

Turning now to the seven service elements. Code cleansing includes restructuring of code for modularizing of duplicate functions, removal of dead code, code enhancement for performance improvement, and documentation of code for maintainability. Code conversion includes code rewrite from one language to another (e.g. COBOL to JAVA code rewrite), upgrade of code from one version to the next version, and code porting from one operating system to another (e.g. HP-UX to AIX or AIX to LINUX). Data migration includes migration from a non-relational to a relational database, migration from one relational database to another relational database, migration from one data schema to another data schema, and porting data from one operating system to another. EAI (enterprise application integration) includes implementation of common middleware to implement a messaging infrastructure between applications, standardization of messaging API between applications with the use of middleware, implementation of data transformation and rules based message routing capability between databases and applications, and implementation of a publish/subscribe feature for messages between applications. Portal implementation includes web access to the legacy applications and data through portlets, common access to portlets through implementation of a web portal, and logical grouping of applications and content. Componentization and web services includes componentization of application functionality into distinct modular services, extraction of business rules, transformation of code into reusable web services, and deployment of the web services for shared reusable access by multiple applications. The workflow service element includes modeling process flows, redesigning process flows, and implementation of workflow management for process improvement and automation.

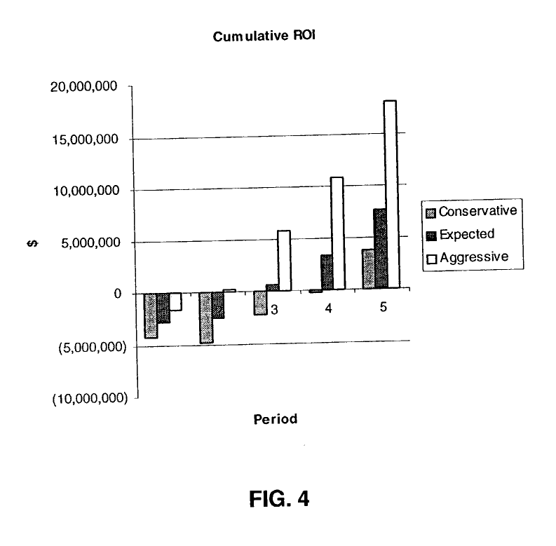

In FIG. 4 there is shown an example of ROI calculation results in the form of a bar graph. In addition to the expected return, there is shown results for a conservative and aggressive ROI calculation. As is typical for successful plans, the ROI calculation shows positive returns for later years, as savings increase. Such a bar graph may be included in an executive summary.

In FIG. 5 there is shown a spreadsheet page for entering data for a value driver for a service element. The value driver in FIG. 5 is 51 business savings due to reduced system downtime.

The spreadsheet page may be used to evaluate business value such as benefit cash flow 52 for each of the periods P1-P5 for this value driver.

Table 1 below lists sixteen value drivers included in one embodiment of the invention.

### Table 1—Value Drivers

1. reduced time to test and fix application

2. decreased time to develop enhancements

3. decreased platform/hardware and network costs

4. reduced development cost of supporting interoperability across multiple applications

5. reduced operational cost to support new business requirements

6. decreased cost to move and re-key data (reduces cost of supplying data to/from/within business)

7. business savings due to reduced system downtime

8. decreased software costs (reduction of licenses)

9. decreased cost to build/maintain internet/intranet sites and distribute communication materials

10. portal impact on information research and access (internal end-user productivity)

11. impact on application training cost

12. reduced travel expenses

13. reduced demand for help desk support

14. improved data quality and data availability

15. impact on sales (due to reduced time to market, customer satisfaction, etc.)

16. increased business flexibility (specific future options due to legacy transformation)

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of transforming legacy business services for a client, comprising the steps of:
predefining components having service elements and corresponding questions, based on market research;
receiving from a client parameters for said service elements as responses to said questions;
selecting and pricing service elements for said client by determining business value of said service elements from said parameters; and
delivering the selected service elements to said client.

2. The method of claim 1, wherein said service elements are e-business on demand service elements.

3. The method of claim 1, wherein said business value includes a return on investment calculation.

4. The method of claim 1, wherein said business value includes an internal rate of return calculation.

5. The method of claim 1, wherein said business value is determined by evaluating predefined value drivers for each said service element.

6. The method of claim 1, wherein delivering the selected service elements further comprises installing said selected service elements on a server computer, and providing client access to said selected service elements.

7. The method of claim 1, further comprising the step of billing said client for said selected service elements based on use.

8. A program storage device readable by a machine, tangibly embodying a program of instructions executable by a machine to perform method steps for transforming legacy business services for a client, comprising:
predefining components having service elements and corresponding questions, based on market research;
receiving from a client parameters for said service elements as responses to said questions;
selecting and pricing service elements for said client by determining business value of said service elements from said parameters; and
thereafter, delivering the selected service elements to said client.

9. The method of claim 8, wherein said service elements are e-business on demand service elements.

10. The method of claim 8, wherein said business value includes a return on investment calculation.

11. The method of claim 8, wherein said business value includes an internal rate of return calculation.

12. The method of claim 8, wherein said business value is determined by evaluating predefined value drivers for each said service element.

13. The method of claim 8, wherein delivering the selected service elements further comprises installing said selected service elements on a server computer, and providing client access to said selected service elements.

14. The method of claim 8, further comprising the step of billing said client for said selected service elements based on use.

15. A business method of providing information technology service to a client for transforming legacy applications, comprising the steps of:
predefining components having service elements for legacy applications of a client, each said service element having one or more value drivers with corresponding parameters;
determining values for said corresponding parameters through collaboration with said client;
selecting service elements for said legacy applications of said client based on evaluating said value drivers using said values for said corresponding parameters; and
delivering the selected service elements to said client.

16. The method of claim 15, wherein said components comprise consolidation and migration, application integration, web enablement, and application renovation.

17. The method of claim 15, further comprising evaluating a return on investment for said client for said selected service elements.
